(19) United States
(12) Patent Application Publication
(10) Pub. No.: US 2024/0229193 A9
(43) Pub. Date: Jul. 11, 2024

(54) DEVICE FOR PREPARING ULTRA-HIGH-PURITY ZINC BASED ON INTELLIGENTLY-CONTROLLED ZONE MELTING

(71) Applicants: XI'AN JIAOTONG UNIVERSITY, Xi'an (CN); Shaanxi Zinc Industry Co., Ltd, Shangluo (CN)

(72) Inventors: Shengqiang MA, Xi'an (CN); Ping LV, Xi'an (CN); Xudong CUI, Shangluo (CN); Yusheng LIU, Xi'an (CN); Xuebin HE, Shangluo (CN); Jiaxu CHEN, Xi'an (CN); Jiandong XING, Xi'an (CN); Jiankang ZHANG, Shangluo (CN); Xiaoru ZHAO, Shangluo (CN)

(21) Appl. No.: 18/542,505

(22) Filed: Dec. 15, 2023

(30) Foreign Application Priority Data
Sep. 19, 2023 (CN) 202311215261.0

(51) Int. Cl. C22B 19/32

(52) U.S. Cl. CPC C22B 19/32

(57) ABSTRACT

A device for preparing ultra-high purity zinc based on intelligently-controlled zone melting, including a slide platform connected with a screw through a servo control system to control movement of a heating-cooling device. A quartz tube is provided inside an induction heater to protect a melting zone. An infrared thermometer is connected to the heater, and configured to monitor temperature within the melting zone, and control power of the heater. A ring magnetic stirrer with non-contact circumferential rotation cooperates with coil to stir zinc melt. A water-cooling copper jacket is connected to two ends of the heater to cool a zinc bar, and its water inlet and outlet are connected with a water chiller. The infrared thermometer monitors temperature of the zinc bar and controls water flow of the cooling system. A lifting device is connected with a base cabinet to change inclined angle of the zinc bar.

### CROSS-REFERENCE TO RELATED APPLICATIONS

This application claims the benefit of priority from Chinese Patent Application No. 202311215261.0, filed on Sep. 19, 2023. The content of the aforementioned application, including any intervening amendments thereto, is incorporated herein by reference in its entirety.

### TECHNICAL FIELD

This application relates to preparation devices of high-purity metals, and more particularly to a device for preparing ultra-high-purity zinc based on intelligently-controlled zone melting, which can be applied to efficient purification and refining of 6N and 7N high purity zinc.

### BACKGROUND

With the rapid development of fifth-generation (5G) telecommunication technology and the advancement of the fourth industrial revolution, the development of ultra-high purity metals and preparation technology thereof has played a key role in the development of strategy materials in the fields of semiconductor and electronic devices, nuclear industry, and aerospace. The ultra-high-purity zinc is mainly used in the preparation of ZnSe, ZnO, ZnS, ZnTe, CdZnTe (ZCT) and other crystal materials with high performance, and is also often used as a p-type semiconductor dopant to improve performance of conductive polymers, which is widely accepted as an important basic material in the preparation of compound semiconductors. However, the presence of ppm-level impurities or sub-ppm-level impurities will significantly affect physical and chemical properties of materials and performances of semiconductors. Therefore, it is of great significance to develop technologies of preparing ultra-high-purity zinc and reducing content of impurity elements in the high-purity zinc for the development of China's electronics, automotive, aerospace and nuclear industries.

At present, the 7N ultra-high-purity zinc can only be prepared by zone melting method. In the zone melting method, the separation and purification are performed based on the diffusion rate differences of impurities in liquid and solid phase during the non-equilibrium crystallization process and segregation and crystallization characteristics (segregation coefficient) of impurities at the solidification interface, and the ultra-high purification of zinc is achieved by means of solute redistribution at the solid/liquid interface during the solidification. Equilibrium concentrations of impurities in solidified zinc and molten zinc are defined as C_{S} and C_{L}, respectively, and a ratio of C_{S} to C_{L} is defined as an equilibrium distribution coefficient k. When the liquid phase moves slowly along a solid ingot under heating, unidirectional solidification occurs in a melting zone, and the impurities will be accumulated at a head or tail end of the ingot according to differences in the equilibrium distribution coefficient k. Under strict control of segregation characteristics and crystallization behavior of the solidification interface, the zinc purity can reach the electronic grade or above after several purification operations. Regarding the commercially-available zone melting-based purification devices, a high-purity zinc ingot is placed horizontally on a graphite boat and purified through the one-way movement of a heater coil.

However, the traditional zone melting-based purification devices have some limitations. First, the irregular flow of a fluid at the solidification interface of the high-purity zinc ingot in the molten and unprotected state will inevitably lead to uneven distribution of the impurities, and the convective mass transfer of the impurities to the solidification end will result in serious impurity retention effect (that is, the impurities enter the solid phase or are trapped in the solid phase because of counter-convective diffusion and high solidification rate), thereby significantly reducing the purification effects. Second, axial heat conduction of the high-purity zinc ingot during the heating process will reduce the temperature gradient of a solid-liquid interface in the melting zone, attenuating the purification effects. Moreover, a length of the melting zone and moving speed during the zone melting process will also affect the purification effects. Third, the purification based on diffusion rate of impurities in the melting zone has very low efficiency, and the solidification rate is usually higher than the diffusion rate, such that the purification can be only performed at an extremely low moving speed, greatly limiting the purification effects and efficiency. The existing zone melting devices can not efficiently solve the above limitations in the purification process.

### SUMMARY

In view of the shortcomings of the prior art, the present disclosure provides a device for preparing ultra-high-purity zinc based on intelligently-controlled zone melting to solve technical problems that the ultra-high-purity zinc with a grade of 7N or above urgently needed in the preparation of advanced devices (e.g., compound semiconductors and photosensitive materials) cannot be prepared by electrolytic refining and vacuum distillation; the zone melting-based metal purification devices cannot be intelligently controlled; and it is difficult to coordinately control purification parameters, and the purification effects are limited. This application realizes the intelligent control of the zone melting process.

Technical solutions of the present disclosure are described as follows.

The present disclosure provides a device for preparing ultra-high-purity zinc based on intelligently-controlled zone melting, comprising:
a melting device; and
a first base cabinet;
wherein the melting device is provided on a top of the first base cabinet; an interior of the first base cabinet is provided with a lifting device; the lifting device with a tilt sensor is connected with a bottom of the melting device to change an inclined angle of the melting device; a glass cover is sleevedly provided outside the melting device, and a top of the glass cover is provided with a ventilator; an outer side of the first base cabinet is provided with a screen holder, and a control and monitoring system is provided on the screen holder; and the control and monitoring system is connected with the melting device and the lifting device.

In an embodiment, the melting device includes a base; a clamp and a slide platform are correspondingly provided on the base; the clamp is provided with a to-be purified test bar; a heating-cooling device, a ring magnetic stirrer and a pair of infrared thermometers are arranged on the slide platform; the heating-cooling device and the magnetic stirrer are sleeved on the to-be-purified test bar; and the heating-cooling device, the ring magnetic stirrer and the pair of infrared thermometers are connected with the control and monitoring system.

In an embodiment, the number of the clamp is two, and two clamps are connected with a first adjustable support and a second adjustable support, respectively; a bottom of the first adjustable support is fixedly connected with the base through a second base cabinet; and the second adjustable support is connected with a first screw through a first servo motor, and an end of the screw is provided with a coupling.

In an embodiment, two sliding rails are arranged in parallel on the base, and the slide platform is arranged on the two sliding rails; and a bottom of the slide platform is connected with a second screw through a second servo motor.

In an embodiment, an outer side of each of the two sliding rails is provided with a slide limiter.

In an embodiment, the heating-cooling device includes a water-cooling copper jacket; the water-cooling copper jacket adjacent to the induction heater is sleeved on the to-be-purified test bar to strictly constraint the heat concentration focusing on the heating zone of the zone melting and control the temperature gradient of solid/liquid solidification interface; a middle of the water-cooling copper jacket is provided with an induction heater; and a quartz tube is sleeved through the induction heating coil as the induction heater, and the to-be-purified test bar with longer length is placed through the quartz tube.

In an embodiment, the water-cooling copper jacket is correspondingly provided with a water inlet, a water outlet, an air inlet and air outlet; and the water inlet and the water outlet are connected with a cooling system, and the air inlet and the air outlet are connected with a protective gas cylinder.

In an embodiment, an interior of the water-cooling copper jacket is provided with a spirally-grooved air channel; and an inert protective gas is configured to be fed from the protective Ar gas cylinder to the heating-cooling device through the air inlet, and fill the heating-cooling device along the spirally-grooved air channel.

In an embodiment, the ring magnetic stirrer is provided outside the induction heater; and the ring magnetic stirrer is configured to rotate circumferentially and move directionally with the induction heater synchronously.

In an embodiment, the lifting device includes an actuator, and the actuator is provided in the first base cabinet; the actuator is connected with a first end of a connection plate through an actuator screw; and a second end of the connection plate is connected with the base of the melting device.

Compared to the prior art, the present disclosure has the following beneficial effects.

The device of the present disclosure can realize fast zone melting of a zinc bar by using a high-power heating device, and can improve impurities distribution in melting zone by using a non-contact ring magnetic stirrer. Moreover, the cooled zinc bar section adjacent to the melting zone of the zinc bar can be further controllably cooled by the cooling system, so as to increase temperature gradient of a solid/liquid interface and strictly constraint the heat concentration focusing on the heating zone and also improve the purification effects and efficiency. The movement of the heating-cooling device is controlled by a step motor, such that influence of process parameters on the purification effects can be studied and coordinately regulated. Moreover, the lifting device with a tilt sensor can restrain the zinc melt of the melting zone to reduce the irregular and reverse flow of the melt (i.e., overcome irregular flow resulting from the gravity and surface tension of zinc melt) so as to well remove the impurities of the zinc melt.

In an embodiment, the infrared thermometer carries out a multi-point sensing monitoring of temperature and melting state via temperature variation of the cooled zinc bar, and feeds back sensing signals to the control system to control water flow of the cooling system and adjust the pulsed heating power of the heater, cooling effect of the zinc-bar cooled section and temperature gradient of solid/liquid solidification interface in real time.

In an embodiment, the two sliding rails and the slide platform are configured to cooperate to bear the heating-cooling device to move. The first screw is fixed on the base through first supports on two ends of the first screw, and the second screw is fixed on the base through second supports on two ends of the second screw. The first screw and the second screw are accurately controlled to move by a servo module. The servo motor is engaged with the first screw and the second screw through threads, and is connected with the slide platform and the support through bolts.

In an embodiment, the interior of the water-cooling copper jacket is provided with the spirally-grooved air channel. The protective gas can be fed through the spirally-grooved air channel to avoid the external impurities entering the melting zone, so as to play a role in blocking and sealing pollution sources of two ends of the melting zone.

In an embodiment, an external ring magnetic stirrer with non-contact circumferential rotation can perform stirring in the melting zone to improve the inherent impurities distribution in the melting zone, allowing for full diffusion of solute atoms.

In summary, regarding the preparation device provided herein, temperature of the melting zone is controllable and adjustable, and can be monitored in real time, so as to render process parameters stable.

The present disclosure will be clearly and completely described below with reference to the embodiments and accompanying drawings.

### BRIEF DESCRIPTION OF THE DRAWINGS

FIG. 1 is a perspective view of a preparation device of ultra-high-purity zinc based on zone melting according to an embodiment of the present disclosure.

FIG. 2 is an assembly diagram of the preparation device according to an embodiment of the present disclosure.

FIG. 3 is a sectional view of a heating-cooling device of the preparation device according to an embodiment of the present disclosure.

FIG. 4 is a schematic diagram of a lifting device of the preparation device according to an embodiment of the present disclosure.

In the figures: 1, first base cabinet; 2, glass cover; 3, ventilator; 4, control system; 5, screen holder; 6, second base cabinet; 7, adjustable support; 8, clamp; 9, to-be-purified test bar; 10, sliding rail; 11, magnetic stirrer; 12, infrared thermometer; 13, slide limiter; 14, slide platform; 15-1, first screw; 15-2, second screw; 16, coupling; 17-1, first servo motor; 17-2, second servo motor; 18, base; 19-1, water inlet; 19-2, water outlet; 20, water-cooling copper jacket; 21-1, air inlet; 21-2, air outlet; 22, induction heater; 23, quartz tube; 24, actuator; 25, actuator screw; 26, connecting bolt; and 27, connection plate.

### DETAILED DESCRIPTION OF EMBODIMENTS

The present disclosure will be further described below with reference to the accompanying drawings and embodiments. Obviously, described herein are only several embodiments of the disclosure, instead of all embodiments. It should be noted that any embodiment made by those skilled in the art based on the content disclosed herein without making creative effort shall fall within the scope of this application defined by the appended claims.

As used herein, the orientation or position relationship indicated by the terms “center”, “vertical”, “transverse”, “up”, “down”, “front”, “back”, “left”, “right”, “vertical”, “horizontal”, “top”, “bottom”, “inside”, “outside”, “a side” and “an end” is based on the orientation or position relationship shown in the accompanying drawings. These terms are only for facilitating and simplifying description of the present disclosure, rather than indicting or implying that the devices or components must have a particular orientation or be constructed and operated in a particular orientation. Therefore, these terms should not be interpreted as the limitation of this application. Besides, the terms “first” and “second” are only descriptive, and should not be understood as indicating or implying relative importance or implicitly specifying the number of technical features indicated. Thus, a feature defined with the terms “first”, “second” may expressly or implicitly include one or more such features. As used herein, “multiple” means two or more unless otherwise clearly stated.

As used herein, unless otherwise expressly specified and limited, the terms “connection”, “linkage” and “fixing” should be interpreted in a broad sense. For example, it can be “fixed connection”, “removable connection” or “integral connection”; it can be “mechanical connection” or “electrical connection”; it can be “direct connection” or “indirect connection through an intermediate medium”; it can be internal communication between two components. For those of ordinary skill in the art, the specific meaning of these terms can be understood in specific cases.

It should be understood that, as used herein, the terms “include” and “comprise” indicate the presence of the described features, entireties, steps, operations, elements and/or components, and do not exclude the presence or addition of one or more other features, entireties, steps, operations, elements, components and/or collections thereof.

It should be understood that the terms used in the description are only used to describing particular embodiments, and cannot be interpreted as the limitation to the protection scope of the disclosure in any way. As used herein, unless otherwise expressly indicated, the terms “a”, “an” and “the” are intended to include the plural form.

It should be understood that the term “and/or” used herein includes any and all combinations of one or more listed items.

The accompanying figures schematically show various structures according to the embodiments of the present disclosure. The figures are not drawn to scale, in which some details are enlarged and some details may be omitted for the purpose of clarity. The shapes of various regions and layers and the relative size and position relationship thereof shown in the figures are only illustrative, and may deviate in practice because of manufacturing tolerances or technical restrictions. Regions/layers with different shapes, sizes and relative positions can be designed by those of ordinary skill in the art according to practical needs.

The present disclosure provides a device for preparing ultra-high-purity zinc based on intelligently-controlled zone melting, in which a quartz tube is adopted to seal and form a zinc melt in a melting zone, and an inert gas is configured to be fed into the melting zone to protect the zinc melt, so as to prevent introduction of any external impurity in the air. At the same time, a synchronous servo system is configured to control a moving speed of a heater and accurately control a moving rate of the melting zone, cooling rate of solidification interface and non-contact stirring intensity of the zinc melt in the melting zone, so as to further improve purification effects. In addition, an actuator of the device is configured to control an inclined angle of an ultra-high purity zinc bar and a horizontal platform to ensure a certain inclined angle of the melting zone and the solidification interface, so as to effectively control directional flow of fluid in the melting zone of the solid-liquid interface and prevent fluid reflux and irregular flow. The zinc melt is stirred by an external magnetic field, and a solidified zinc bar is cooled by using a water-cooling copper jacket, so as to increase a temperature gradient of the solid-liquid interface. At the same time, the irregular flow of fluid of the solid-liquid interface is strictly controlled, so as to realize directional diffusion of the impurities and directionally convective mass transfer.

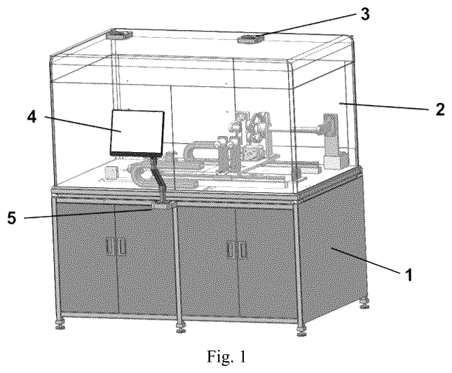

Referring to FIG. 1, the present disclosure provides a device for preparing ultra-high-purity zinc based on intelligently-controlled zone melting, including a first base cabinet 1, a glass cover 2, a ventilator 3, a control system 4 and a melting device in the glass cover 2. The glass cover 2 is arranged on the first base cabinet 1, and the glass cover 2 is connected with the first base cabinet 1 to avoid the melting device being affected by external environment. The ventilator 3 is arranged on a top of the glass cover 2, and the ventilator 3 is configured to discharge gas generated by melting process to maintain constant temperature of the melting device. An interior of the first base cabinet 1 is provided with a lifting device, and the lifting device is connected with the melting device to change the inclined angle of the melting device to avoid irregular flow in the melting zone. The control system 4 is fixed on a side of the first base cabinet 1 through a monitor support 5, and the control system 4 is connected with the melting device and the lifting device to control zone melting process. The present disclosure can complete non-contact uniform stirring of the melt in the melting zone, directional flow of the melt in the melting zone, and a critical early warning and detection and effective purification control of real-time heating/condensation adjustment of the solidification interface and a pulse heater, which is also suitable for purification of other ultra-high purity metals besides zinc.

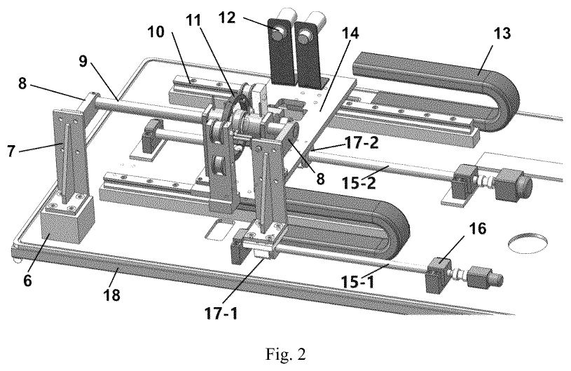

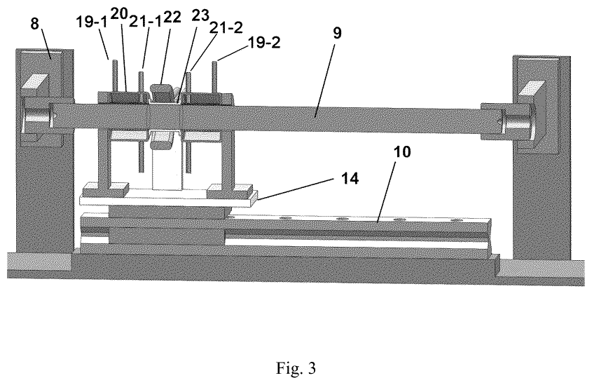

Referring to FIGS. 2-3, the melting device includes a second base cabinet 6, an adjustable support 7, a clamp 8, a to-be-purified test bar 9, a sliding rail 10, a magnetic stirrer 11, an infrared thermometer 12, a slide limiter 13, a slide platform 14, a first screw 15-1, a second screw 15-2, a coupling 16, a first servo motor 17-1, a second servo motor 17-2 and a base 18.

Two ends of the to-be-purified test bar 9 are each connected with the clamp 8 through clamping chucks. The number of the clamp is two, and two clamps 8 are connected with a first adjustable support 7 and a second adjustable support 7, respectively. A bottom of the first adjustable support 7 is fixedly connected with the base 18 through the second base cabinet 6. The second adjustable support 7 is connected with the first screw 15-1 through the first servo motor 17-1, and an end of the first screw 15-1 is provided with a coupling 16. The sliding rail 10 is connected with the slide platform 14 and the slide limiter 13 to restrict a moving path of the melting device, and a heating-cooling device is arranged on the slide platform 14. The magnetic stirrer 11 and the infrared thermometer 12 are connected with the slide platform 14 through supports. The magnetic stirrer 11 is configured to stir in a molten pool, and the infrared thermometer 12 is configured to measure temperature in the molten pool. An end surface of the slide platform 14 is connected with the second servo motor 17-2, and the second servo motor 17-2 is engaged with the second screw 15-2 through threads to drive a reciprocating movement of the slide platform 14, so as to realize multi-pass zone melting and purification process.

A first moving speed of the first servo motor 17-1 and a second moving speed of the second servo motor 17-2 are controllable. The first moving speed and the second speed both have a lowest speed of 0.01 mm/min and a highest speed of 20 mm/min, so as to ensure full melting of the zinc bar and synergistic control of purification efficiency.

The infrared thermometer 12 can feed back and monitor temperature of the melting zone and temperature of the solidified zinc bar in real time. The infrared thermometer 12 is configured to monitor the temperature of the melting zone, which is 460° C.±10° C. Temperature is controlled accurately, and multi-site temperature differences are fed back to respond the control system, so as to control power of the induction heater.

The infrared thermometer 12 is configured to monitor the temperature of the solidified zinc bar, which is 30° C.±10° C., and multi-site temperature is fed back and controlled to adjust water flow in and out of the water-cooling copper jacket. The temperature of the solidified zinc bar is low, allowing for large temperature gradient in the solid/liquid interface, and effective purification effect of the zinc bar.

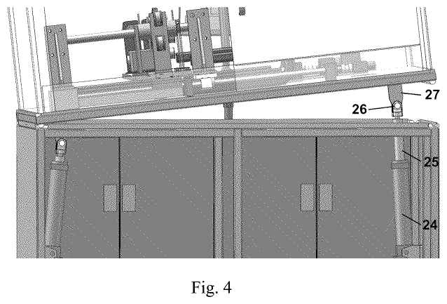

Referring to FIG. 4, the heating-cooling device includes the induction heater 22, a quartz tube 23, the water-cooling copper jacket 20, a water inlet 19-1, a water outlet 19-2, an air inlet 21-1, and an air outlet 21-2.

The induction heater 22 is fixed on the slide platform 14 through the supports. The control system adjusts a heating power of a coil of the induction heater 22 according to the temperature of the melting zone fed back from the infrared thermometer 12. The quartz tube 23 is closely connected with the water-cooling copper jacket 20 to protect the melting zone, so as to avoid the impurities entering the melting zone resulting in decreasing purification effects. The water-cooling copper jacket 20 is fixed on the slide platform 14, and the water inlet 19-1 and the water outlet 19-2 are connected with the cooling system. The water inlet 19-1 and the water outlet 19-2 are connected with a water chiller. The control system is configured to adjust water flow in and out according to the temperature of the zinc bar fed back from the infrared thermometer 12, and is configured to control constant temperature gradient of the solid/liquid interface. The air inlet 21-1 and the air outlet 21-2 are connected with a protective gas cylinder. An interior of the water-cooling copper jacket 20 is provided with a spirally-grooved air channel. And the protective gas is configured to be fed from the protective gas cylinder to the fills the heating-cooling device through the air inlet 21-1, and fill the heating-cooling device along the spirally-grooved air channel.

The induction heater 22, which is a pulse heater with fast response, is configured to heat the zinc bar. The induction heater 22 has a large heating rate, a flexible adjustment of temperature range and a heating rate of 25 kW, so as to realize fast zone melting of the zinc bar.

Referring to FIG. 5, the lifting device includes an actuator 24, an actuator screw 25, a connecting bolt 26 and a connection plate 27. An interior of the actuator 24 is engaged with the actuator screw 25 through threads. The connecting bolt 26 is connected with the actuator screw 25 and the connection plate 27 to support the base cabinet of the melting device. The actuator 24 is configured to drive the actuator screw 25 to reciprocate up and down, so as to change the inclined angle of the melting device and avoid irregular flow in the melting zone.

The actuator 24 can control the inclined angle of the melting device to change within a range of 0°˜±45°, which can restrain the melt and limit the irregular flow of the melt.

The control system 4 is provided with a three-layer system structure with integrated management and control, where the first layer is a management and monitoring layer; the second layer is a control and execution layer; and the third layer is a device layer. The data communication and sensing transmission between the first layer and the second layer are enabled through an industry bus. A programmable controller is configured as a lower computer (control and execution layer) to process field detection parameters and control a controlled object in real time. An industrial personal computer is configured as an upper computer (management and monitoring layer) to read data from the lower computer, so as to carry out dynamic display, data processing and static storage.

Buttons on an operating panel are operated to allow the control system 4 to convert a mechanical signal into an electrical signal. The electrical signal is transmitted to a control circuit through a signal line, and the control circuit further drives the device to work. After that, a physical signal (such as temperature of mantling zone, tilt angle of platform, rotating speed of magnetic stirrer, etc.) is converted into the electrical signal, and transmitted to the control circuit by a sensing element. The electrical signal is coded and translated by the control circuit and then is transmitted to the display, so as to achieve an integrated visualized-intelligent control. The purified test bar has excellent dimensional accuracy and dimensional stability.

Operation steps of the preparation device of the present disclosure are described as follows.
(S1) The preparation device is connected to a power supply, and the power light is on.
(S2) The control system 4 is turned on, and the glass cover 2 is opened.
(S3) The clamp 8 is opened, and the high-purity zinc bar is loaded and fixed.
(S4) The air inlet and outlet of the water-cooling copper jacket are connected with the protective gas cylinder, and whether the protective gas can be normally fed is checked.
(S5) The ventilator 3 is turned on.
(S6) The water inlet and outlet of the water-cooling copper jacket are connected with the water chiller.
(S7) A power supply of the water chiller is turned on, and whether the water circulation is normal is checked.
(S8) The glass cover 2 is closed, and heating parameters, moving speed of the melting zone and an inclined angle are set to start heating.
(S9) After the first-pass zone melting of the zinc bar is completed, the melting device is set to move reversely.
(S10) After the multi-pass zone melting is finished, the heating is stopped to allow the zinc bar to be naturally cooled.
(S11) The clamp 8 is disassembled, and the zinc bar is collected.
(S12) The water chiller is turned off, and the protective gas cylinder is disconnected from the water-cooling copper jacket.
(S13) Residual zinc on the clamp, the water-cooling copper jacket and the quartz tube is cleaned.
(S14) The slide platform is reset to an initial state.
(S15) The glass cover is closed, and the control system is turned off.
(S16) The power supply of the preparation device is cut off.

In the above process, the second-pass purification can be directly carried out after the first-pass zone melting is completed. The heating-cooling device is controlled to move reversely so as to effectively improve purification efficiency of the zinc bar. After the water-cooling copper jacket is connected with circulating water and a gas protection device, it is required to ensure that the quartz tube is sealed to isolate the melting zone from the external environment, so as to reduce introduction of external impurities. An inclined angle of the zinc bar is changed by controlling the lifting device, such that the melt is restrained by gravity, so as to reduce irregular flow of the melt.

In summary, the device for preparing ultra-high-purity zinc based on intelligently-controlled zone melting has a pulse induction heater with high power and fast heating, which can realize fast zone melting of the zinc bar. A diffusion of solute atoms can be effectively promoted by stirring the melting zone with a circumferential rotating magnetic field, so as to homogenize composition of the zinc bar. The cooling system can fully reduce a temperature of a cooled zinc bar and increase the temperature gradient of the solid/liquid interface. An inert gas protection device is configured to avoid air entering the melting zone, so as to reduce induction of the impurities. The first servo motor and the second servo motor are configured to control a movement of the heating-cooling device, so as to control the moving rate of the melting zone and match other key parameters to improve purification effects and a purification rate of the ultra-high zinc bar. The actuator is configured to control lift and fall of the base, which can effectively restrain the melt and limit the irregular flow of the melt.

Described above are only some embodiments of this application, and are not intended to limit this application in any form. Though the disclosure has been described in detail above, various variations, improvements and modifications can still be made by those skilled in the art. It should be noted that those variations, improvements and modifications made without departing from the spirit of this application shall fall within the scope of this application defined by the appended claims.

What is claimed is:

1. A device for preparing ultra-high-purity zinc based on intelligently-controlled zone melting, comprising:
a melting device; and
a first base cabinet;
wherein the melting device is arranged on a top of the first base cabinet; an interior of the first base cabinet is provided with a lifting device; the lifting device is provided with a tilt sensor, and is connected with a bottom of the melting device to change an inclined angle of the melting device; a glass cover is sleevedly provided outside the melting device, and a top of the glass cover is provided with a ventilator; an outer side of the first base cabinet is provided with a screen holder, and a control and monitoring system is provided on the screen holder; and the control and monitoring system is connected with the melting device and the lifting device.

2. The device of claim 1, wherein the melting device comprises a base; a clamp and a slide platform are correspondingly provided on the base; the clamp is provided with a to-be-purified test bar; a heating-cooling device, a ring magnetic stirrer and a pair of infrared thermometers are arranged on the slide platform; the heating-cooling device and the ring magnetic stirrer are sleeved on the to-be-purified test bar; and the heating-cooling device, the ring magnetic stirrer and the pair of infrared thermometers are connected with the control and monitoring system.

3. The device of claim 2, wherein the number of the clamp is two, and two clamps are connected with a first adjustable support and a second adjustable support, respectively; a bottom of the first adjustable support is fixedly connected with the base through a second base cabinet; and the second adjustable support is connected with a screw through a servo motor, and an end of the screw is provided with a coupling.

4. The device of claim 2, wherein two sliding rails are arranged in parallel on the base, and the slide platform is arranged on the two sliding rails; and a bottom of the slide platform is connected with a screw through a servo motor.

5. The device of claim 4, wherein an outer side of each of the two sliding rails is provided with a slide limiter.

6. The device of claim 2, wherein the heating-cooling device comprises a water-cooling copper jacket; the water-cooling copper jacket is sleeved on the to-be-purified test bar; a middle of the water-cooling copper jacket is provided with an induction heater; and a quartz tube is sleeved on the induction heater.

7. The device of claim 6, wherein the water-cooling copper jacket is correspondingly provided with a water inlet, a water outlet, an air inlet, and an air outlet; the water inlet and the water outlet are connected with a cooling system; and the air inlet and the air outlet are connected with a protective gas cylinder.

8. The device of claim 7, wherein an interior of the water-cooling copper jacket is provided with a spirally-grooved air channel; and an inert protective gas is configured to be fed from the protective gas cylinder to the heating-cooling device through the air inlet, and fill the heating-cooling device along the spirally-grooved air channel.

9. The device of claim 6, wherein the ring magnetic stirrer is provided outside the induction heater; and the ring magnetic stirrer is configured to rotate circumferentially, and move directionally with the induction heater synchronously.

10. The device of claim 1, wherein the lifting device comprises an actuator arranged in the first base cabinet; the actuator is connected with a first end of a connection plate through a screw; and a second end of the connection plate is connected with the base of the melting device.
